(19) United States
(12) Patent Application Publication
(10) Pub. No.: US 2009/0013340 A1
(43) Pub. Date: Jan. 8, 2009

(54) OPTICAL DISC DRIVE

(75) Inventor: Masaomi Izumisawa, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/164,790

(22) Filed: Jun. 30, 2008

(30) Foreign Application Priority Data
Jul. 6, 2007 (JP) 2007-178991

(51) Int. Cl. G11B 17/03

(52) U.S. Cl. 720/610

(57) ABSTRACT

According to one embodiment, an optical disc drive includes a case having a guide portion, a disc tray which is located in the case and carries an optical disc thereon, a guide mechanism which includes a rail slidably mounted on the disc tray and slidably supported on the guide portion of the case and supports the disc tray for movement between a loaded position in which the disc tray is situated in the case and a drawn-out position to which the disc tray is drawn from the case, a locking mechanism, and an ejection mechanism configured to discharge the disc tray from the loaded position to the drawn-out position. The ejection mechanism includes a groove portion formed in the rail or the disc tray, and a compression coil spring located in the groove portion and configured to urge the disc tray toward the drawn-out position.

### CROSS-REFERENCE TO RELATED APPLICATIONS

This application is based upon and claims the benefit of priority from Japanese Patent Application No. 2007-178991, filed Jul. 6, 2007, the entire contents of which are incorporated herein by reference.

### BACKGROUND

1. Field

One embodiment of the invention relates to an optical disc drive for recording or reproducing information to or from a disc information recording medium, e.g., an optical disc.

2. Description of the Related Art

In recent years, as is generally known, optical disc drives have been used as information recording/reproducing apparatuses for recording and reproducing information to and from optical discs, such as compact discs (CDs), digital versatile discs (DVDs), high-definition digital versatile discs (HD-DVDs), etc.

Among these optical disc drives, a slim optical disc drive that is incorporated in, for example, a computer is provided with a case in the form of a flat, rectangular box and a disc tray that is set in a drawable manner in the case. The disc tray supports a turntable for supporting and rotating an optical disc and a drive section, such as an optical pickup, for recording and reproducing information to and from the disc on the turntable.

Two opposite side portions of the disc tray are slidably supported by a pair of elongated rail members, individually, and the rail members are supported so as to be slidable with respect to the case. Thus, the disc tray is supported for movement between a predetermined loaded position in the case and a drawn-out position in which it is drawn out of the optical disc drive to allow the optical disc to be loaded or unloaded on the tray. In loading the optical disc into the disc drive, the disc tray is drawn out of the case, and the disc is set on the tray. Thereafter, the tray is moved again into the loaded position in the case by a user's manual operation.

In general, a disc tray is urged to be drawn out by a spring member that constitutes an ejection mechanism. When it is moved to the loaded position, the tray is locked in this position. In ejecting the optical disc, the disc tray is unlocked so that it is urged by the spring member to be pushed out into a position where it projects from the case.

According to an optical disc reproducing apparatus described in Jpn. Pat. Appln. KOKAI Publication No. 9-282763, for example, a tension spring is used as a spring member, one end of which is fixed to a spring retainer that is attached to a disc tray. A block-shaped tray extruding member is mounted on the other end of the tension spring. As the disc tray is pushed from its drawn-out position into a predetermined loaded position, the extruding member engages with a rail member on the way. If the disc tray is further pushed in, the tension spring is pulled to generate an urging force. If the tray is unlocked to eject the optical disc, it is pulled in a draw-out direction by the spring and pushed out into a position where it projects from a case.

In the optical disc apparatus constructed in this manner, however, it is necessary to form the spring retainer for fixing the one end of the spring member on the disc tray and to mount the spring member on the spring retainer. Further, the block-shaped extruding member must be prepared and mounted the other end of the spring member. Accordingly, a plurality of components are required in addition to the spring for this purpose, and assembly involves mounting of these components. Thus, the aforesaid optical disc apparatus requires so many components that its reliability is reduced. Further, an increase in the number of assembly processes entails a cost increase.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an outline of an optical disc drive according to a first embodiment of the invention;

FIG. 2 is an exemplary exploded perspective view showing a case, a disc tray, and an optical disc of the optical disc drive;

FIG. 3 is an exemplary exploded perspective view showing the disc tray, the case, and rails;

FIG. 4 is an exemplary exploded perspective view showing the disc tray and the rails;

FIG. 5 is an exemplary perspective view showing one of the rails;

FIG. 6 is an exemplary enlarged perspective view showing a part of the rail;

FIG. 7 is an exemplary perspective view showing the rail fitted with a compression coil spring;

FIG. 8 is an exemplary perspective view showing the rail and the compression coil spring in a compressed state;

FIG. 9 is an exemplary enlarged perspective view showing a part of the rail and the compression coil spring;

FIG. 10 is an exemplary sectional view showing the disc tray and the rail;

FIG. 11 is an exemplary plan view showing the top side of the optical disc drive with the disc tray locked in a loaded position;

FIG. 12 is an exemplary plan view showing the bottom side of the optical disc drive with the disc tray locked in the loaded position;

FIGS. 13A and 13B are exemplary plan views individually showing different operating states of a locking mechanism;

FIG. 14 is an exemplary plan view showing the top side of the optical disc drive with the disc tray in a discharged state;

FIG. 15 is an exemplary plan view showing the bottom side of the optical disc drive with the disc tray in the discharged state;

FIG. 16 is an exemplary plan view showing a rail and a compression coil spring of an optical disc drive according to a second embodiment of the invention;

FIG. 17 is an exemplary plan view showing the rail and the compression coil spring of the optical disc drive according to the second embodiment of the invention;

FIG. 18 is an exemplary plan view showing a disc tray, a rail, and a compression coil spring of an optical disc drive according to a third embodiment of the invention;

FIG. 19 is an exemplary sectional view showing a disc tray, a rail, and a compression coil spring of an optical disc drive according to a fourth embodiment of the invention; and

FIG. 20 is an exemplary exploded perspective view showing the disc tray, the rail, and the compression coil spring of the optical disc drive according to the fourth embodiment of the invention.

### DETAILED DESCRIPTION

Various embodiments according to the invention will be described hereinafter with reference to the accompanying drawings. In general, according to one embodiment of the invention, an optical disc drive comprises: a case including a guide portion; a disc tray which is located in the case so as to be able to be drawn out of the case and carries an optical disc thereon; a guide mechanism which includes a rail slidably mounted on the disc tray and slidably supported on the guide portion of the case and supports the disc tray for movement between a predetermined loaded position in which the disc tray is situated in the case and a drawn-out position to which the disc tray is discharged from the case; a locking mechanism which locks the disc tray in the loaded position; and an ejection mechanism which includes a groove portion formed in the rail or the disc tray and a compression coil spring located in the groove portion and configured to urge the disc tray toward the drawn-out position and discharges the disc tray from the loaded position to the drawn-out position.

Optical disc drives according to embodiments of this invention will now be described in detail with reference to the accompanying drawings.

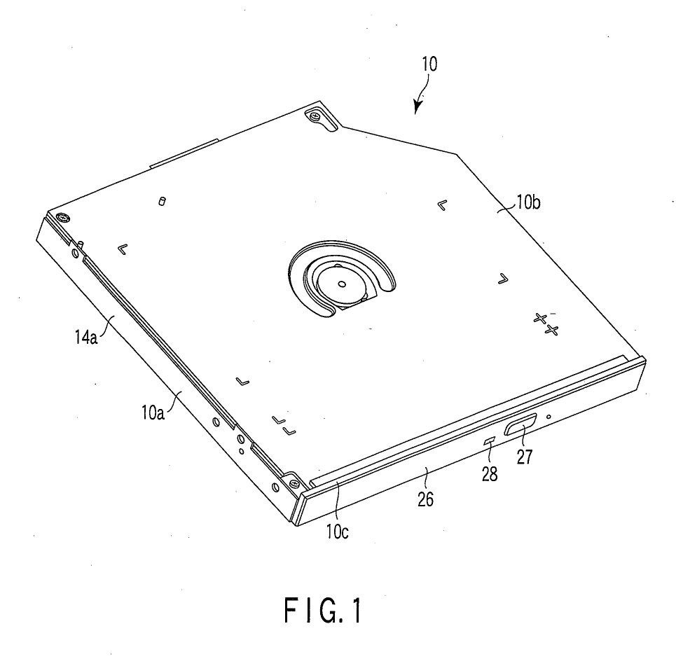

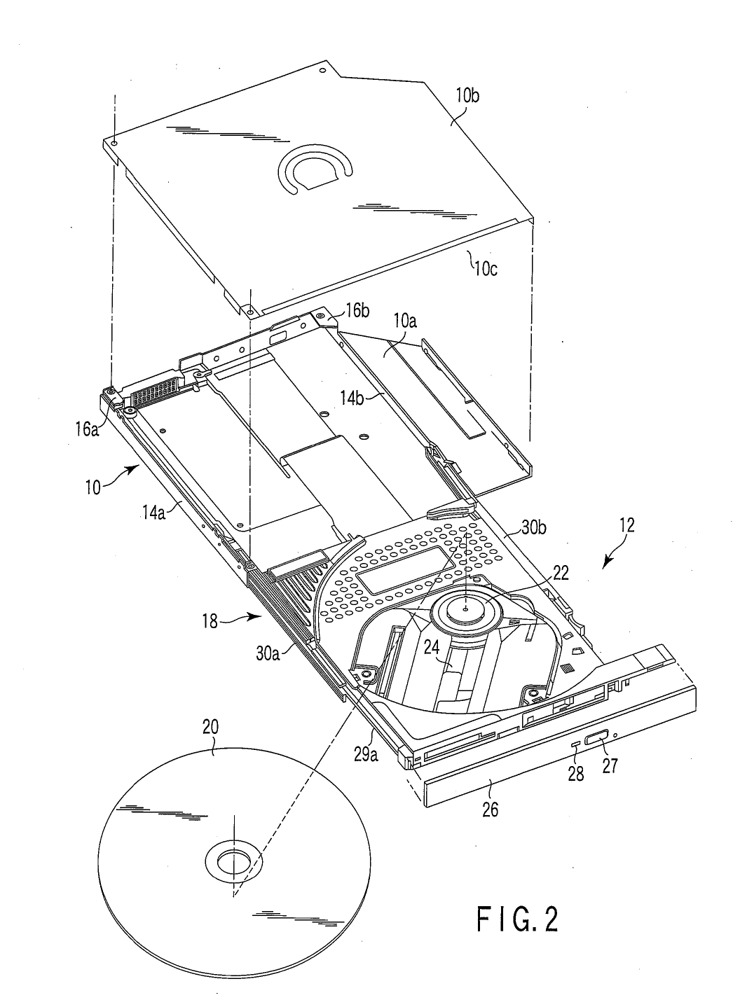

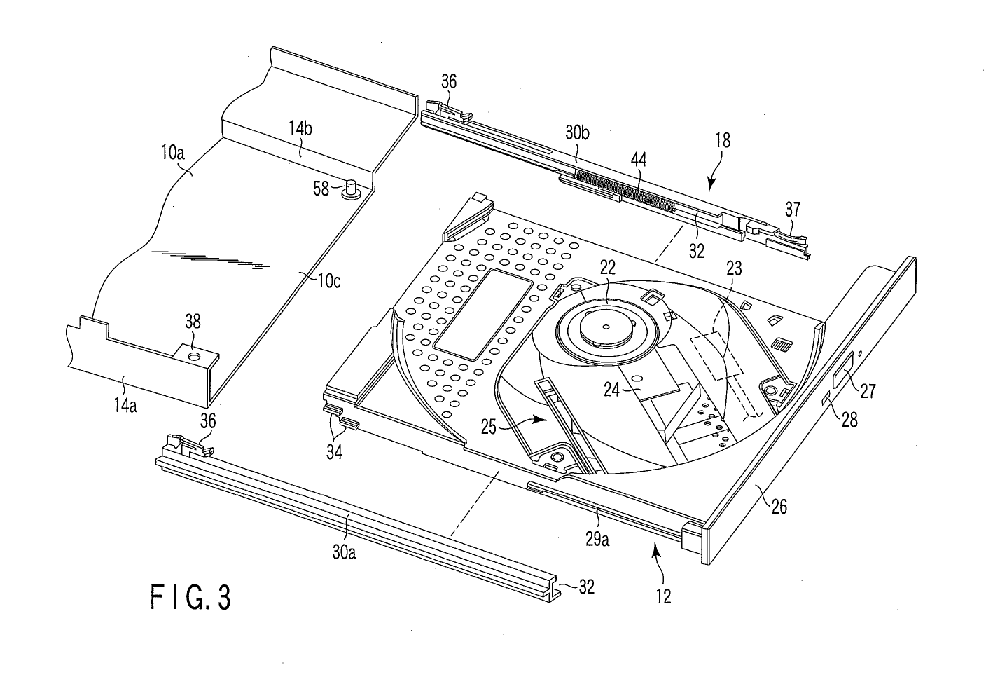

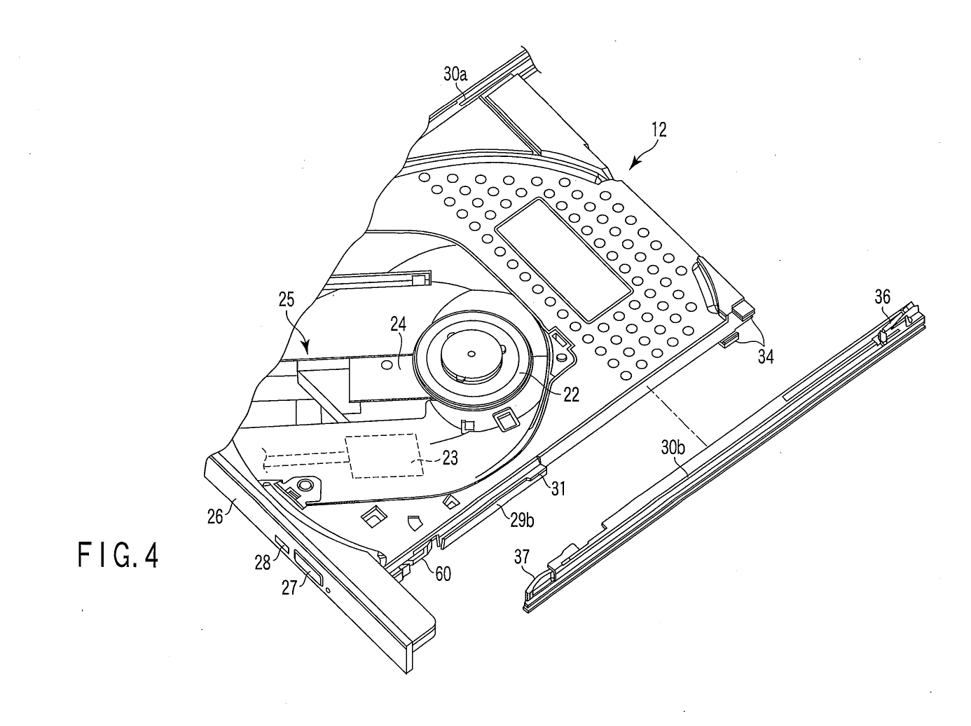

FIG. 1 is a perspective view showing a state in which a disc tray is arranged in a loaded position in an optical disc drive according to a first embodiment. FIG. 2 is an exploded perspective view showing a case, the disc tray, and an optical disc of the optical disc drive. FIGS. 3 and 4 are an exploded perspective views showing the disc tray and rails.

As shown in FIGS. 1 and 2, the optical disc drive is constructed as a slim optical disc drive that is incorporated in a personal computer or the like. The optical disc drive includes a flat, rectangular case 10 and a disc tray 12 arranged in a drawable manner in the case. The case 10 includes a bottom cover 10a and a top cover 10b that constitutes a bottom surface portion and a top surface portion, respectively, of the cover. The bottom cover 10a is a substantially rectangular structure formed of sheet metal, and its entire peripheral edge portion except for an insertion port 10c is bent substantially at right angles and forms a sidewall. Likewise, the top cover 10b is a substantially rectangular structure formed of sheet metal, and it is screwed to the bottom cover 10a in an overlapping manner. The side surface portion of the case 10 opens and defines the insertion port 10c through which the disc tray 12 is passed.

The bottom cover 10a includes a pair of guide portions 14 that serve to guide the rails (mentioned later). The guide portions 14 are formed individually of one sidewall 14a of the bottom cover 10a and a stepped portion 14b formed by raising an intermediate part of the bottom cover. The guide portions 14a and 14b face each other in parallel relation and extend from the insertion port 10c at right angles thereto.

The bottom cover 10a includes rail retainers 16a and 16b that are located at the rear end portions of the sidewall 14a and the stepped portion 14b, respectively. The rail retainers 16a and 16b are formed by bending sheet metal and face the bottom surface of the bottom cover 10a across gaps.

The case 10 contains therein the disc tray 12, which is loaded with an optical disc 20, and a guide mechanism 18 that supports the disc tray in such a manner that the disc tray can be drawn out of the case.

As shown in FIGS. 2, 3 and 4, the disc tray 12 is a substantially rectangular structure that has a width a little smaller than the diameter of the optical disc 20 and a length substantially equal to that of the case 10. A turntable 22 on which the optical disc 20 is mounted is arranged substantially in the central part of the upper surface of the disc tray 12. A spindle motor (not shown) for rotating the turntable is provided on the reverse side of the disc tray. The turntable 22 is coaxially fixed on the rotating shaft of the spindle motor.

The optical disc 20 is fixed on the turntable 22 by means of a fixing pawl (not shown) arranged on the turntable. It is rotated integrally with the turntable by the spindle motor.

The disc tray 12 is provided with an optical pickup 24 and a drive mechanism 25. The optical pickup 24 applies a laser beam to the optical disc 20 and records and reproduces information. The drive mechanism 25 drives the pickup 24 to reciprocate along the radius of the disc 20. The drive mechanism 25 includes a stepping motor 23, a guide rod (not shown), a lead screw (not shown), etc. A locking mechanism (mentioned later), a control circuit board, etc., are provided on the reverse side of the disc tray 12.

Elongated guide ribs 29a and 29b protrudes individually from two opposite side edges of the disc tray 12. The guide ribs 29a and 29b extend along the length of the disc tray 12, that is, in a direction in which the disc tray is drawn out. The ribs 29a and 29b slidably engage with the rails, which will be mentioned later. The rear end face of the guide rib 29b forms an abutting surface 31 that abuts one end of a compression coil spring (mentioned later).

A front panel 26 in the form of an elongated rectangular plate is attached to the front end edge of the disc tray 12. The front panel 26 corresponds in shape and size to the insertion port 10c of the case 10 so that the disc tray 12 covers and closes the insertion port 10c when it is inserted into a loaded position in the case 10. The front panel 26 is provided with an eject button 27 and an LED 28. The button 27 is used to unlock the disc tray 12 when the tray is ejected or drawn out from the case 10. The LED 28 glows when the disc tray 12 is loaded for operation.

The guide mechanism 18 that supports the disc tray 12 is provided with elongated rails 30a and 30b. The rails 30a and 30b are substantially equal in length to the tray 12. Each rail has a substantially rectangular cross section and an inner surface opposed to a side edge of the tray 12. Guide grooves 32 are formed individually in the respective inner surfaces of the rails 30a and 30b and extend along the length of the rails, that is, in the direction in which the disc tray 12 is drawn out.

When the guide ribs 29a and 29b on the disc tray 12 are in engagement with the guide grooves 32, the rails 30a and 30b are attached individually to the opposite side edge portions of the tray 12. In this state, the disc tray 12 is supported on the rails 30a and 30b so as to be slidable in the direction in which it is drawn out. The rails 30a and 30b are prevented from slipping off the disc tray 12 by stoppers 34 on the tray 12.

An elastically deformable engaging pawl 36 is formed on the upper surface of the rear end portion of each of the rails 30a and 30b. Further, a press pawl 37 is formed on the front end portion of the one rail 30b. It is used to push a lock lever of the locking mechanism (mentioned later) to a locked position.

The pair of rails 30a and 30b are inserted into the case 10 and supported so as to be slidable along the guide portions 14a and 14b. Thus, the disc tray 12 is supported by the guide mechanism, which includes the rails 30a and 30b, for movement between the predetermined loaded position in which it is contained in the case 10 and an unloaded position to which the tray is drawn out of the case. The rails 30a and 30b are prevented from slipping out of the case 10 by a stopper 38 on the bottom cover 10a. When the rails 30a and 30b are pushed into the case 10 as the disc tray 12 moves toward the loaded position, moreover, the engaging pawls 36 individually elastically engage with the rail retainers 16a and 16b of the bottom cover 10a. In this manner, the pair of rails 30a and 30b are held in a pushed-in position.

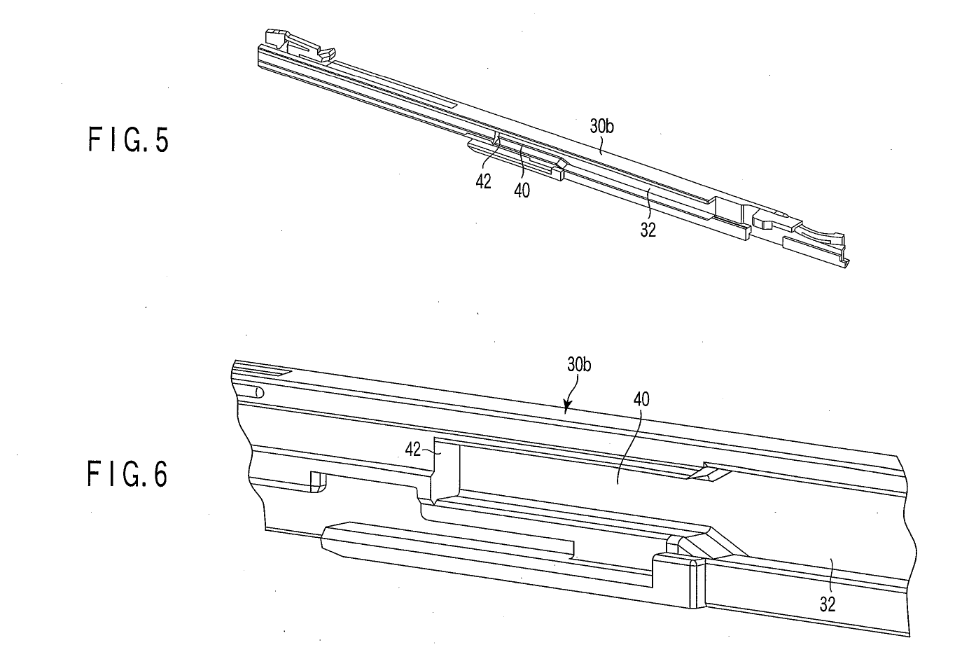

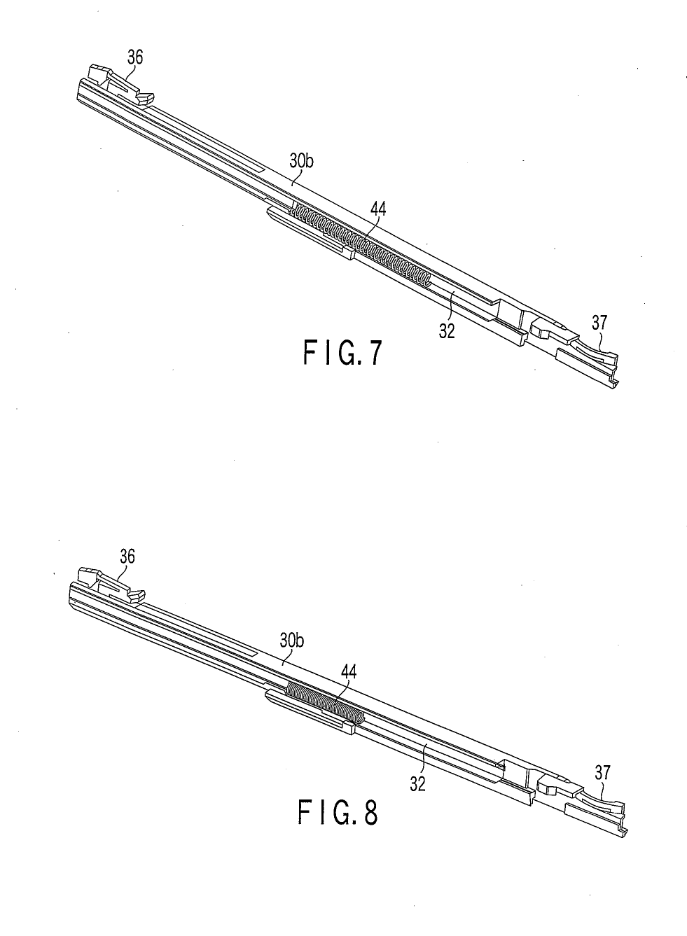

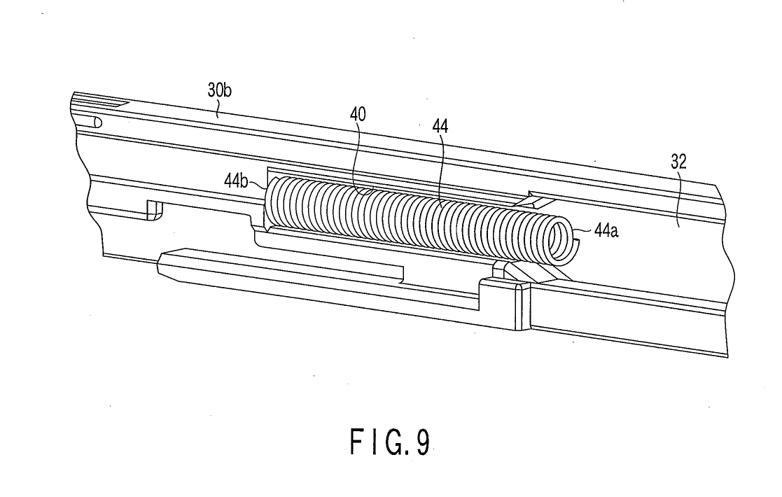

FIGS. 5 and 6 are enlarged views showing the rail 30b in a state before it is fitted with the compression coil spring. Further, FIG. 7 shows the compression coil spring in an uncompressed state, and FIGS. 8 and 9 show the spring in a compressed state.

As shown in FIGS. 5 and 6, a holder groove (groove portion) 40 for the compression coil spring is formed in the inner surface of the rail 30b that faces the disc tray 12. The holder groove 40 opens to a side edge of the tray 12. It is formed continuously with the guide groove 32 and extends in the direction along which the disc tray 12 is drawn out. The holder groove 40 is formed having a depth substantially equal to or a little smaller than the diameter of the compression coil spring (mentioned later). Further, the groove 40 has such a length that a predetermined load can be obtained when the coil spring is compressed.

The holder groove 40 is situated on the push-in side of the disc tray 12 with respect to the guide groove 32. One longitudinal end of the holder groove 40 opens into the guide groove 32, while the other end is closed by a wall surface of the rail 30b. This wall surface extends at right angles to the inner surface of the rail 30b and the holder groove 40 and constitutes an abutting surface 42 on which one end of the compression coil spring abuts.

The rails 30a and 30b constructed in this manner are molded integrally from, for example, a synthetic resin or a metal.

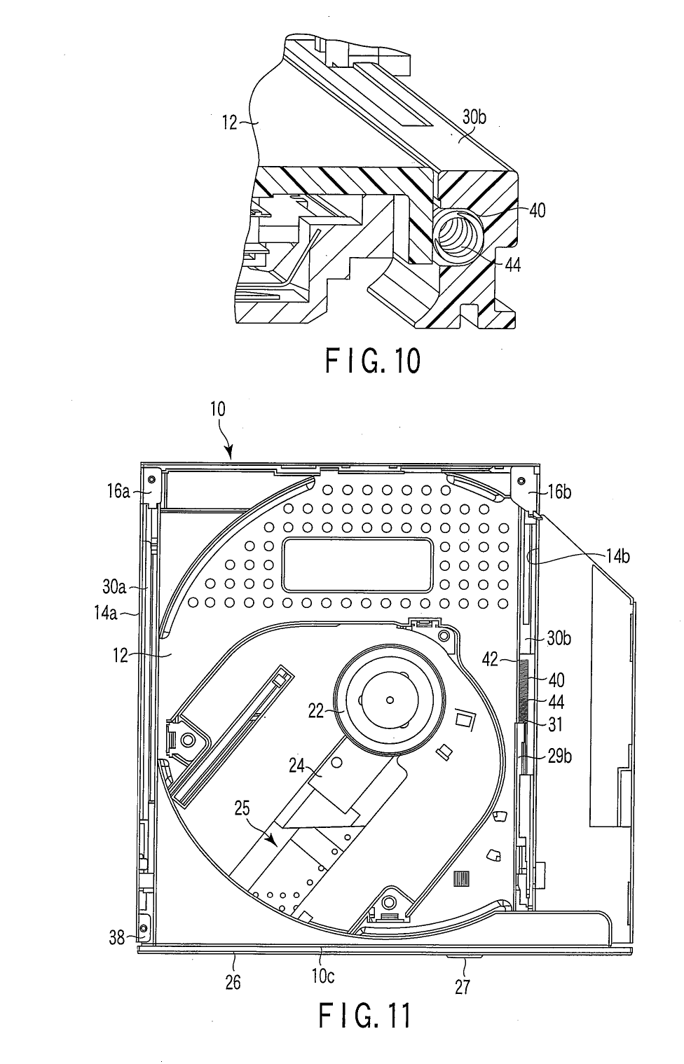

As shown in FIGS. 3 and 7 to 10, a compression coil spring 44 that constitutes an ejection mechanism is arranged in the holder groove 40 of the rail 30b. The spring 44 has a central axis and is located in the holder groove 40 so that the central axis is in alignment with the direction in which the disc tray 12 is drawn out. The spring 44 is located between the rail 30b and the side edge of the disc tray 12. Thus, the spring 44 is held in a predetermined position by only being located in the holder groove 40 without being attached to a spring retainer or the like. One end portion of the compression coil spring 44 extends into the guide groove 32, and its one end 44a faces the abutting surface 31 of the guide rib 29b that protrudes from the disc tray 12. The other end 44b of the spring 44 abuts the abutting surface 42 of the rail 30b.

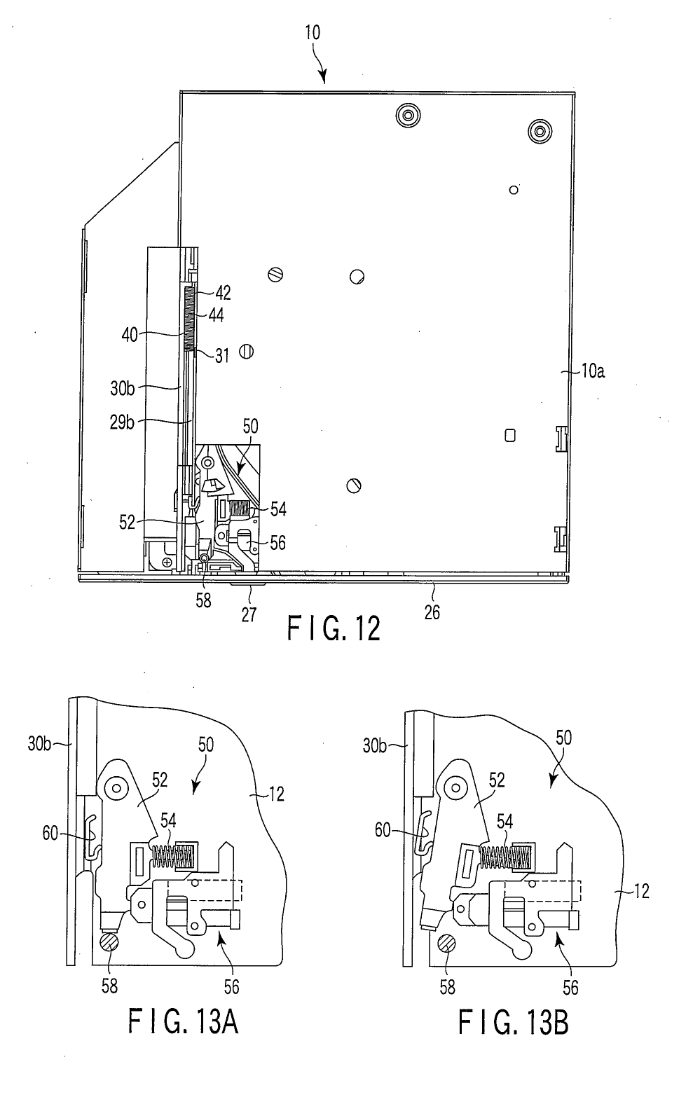

FIGS. 11 and 12 show the top and bottom surfaces, respectively, of the optical disc drive with the disc tray 12 moved to the loaded position in the case 10. When the disc tray 12 is moved to the loaded position in the case 10, as shown in FIGS. 11 and 12, the rails 30a and 30b are inserted into the deepest part of the case 10, and the engaging pawls on their respective rear end portions engage with the rail retainers 16a and 16b, respectively. The disc tray 12 is pushed along the rails 30a and 30b into the loaded position and locked in the loaded position by the locking mechanism (mentioned later). Further, the front panel 26 closes the insertion port 10c of the case 10.

In this state, the compression coil spring 44 of the ejection mechanism is axially pressed and compressed by the abutting surface 31 of the guide rib 29b and the abutting surface 42 of the rail 30b. Thus, the spring 44 is held with storing an urging force in the direction in which the disc tray 12 is discharged to a drawn-out position.

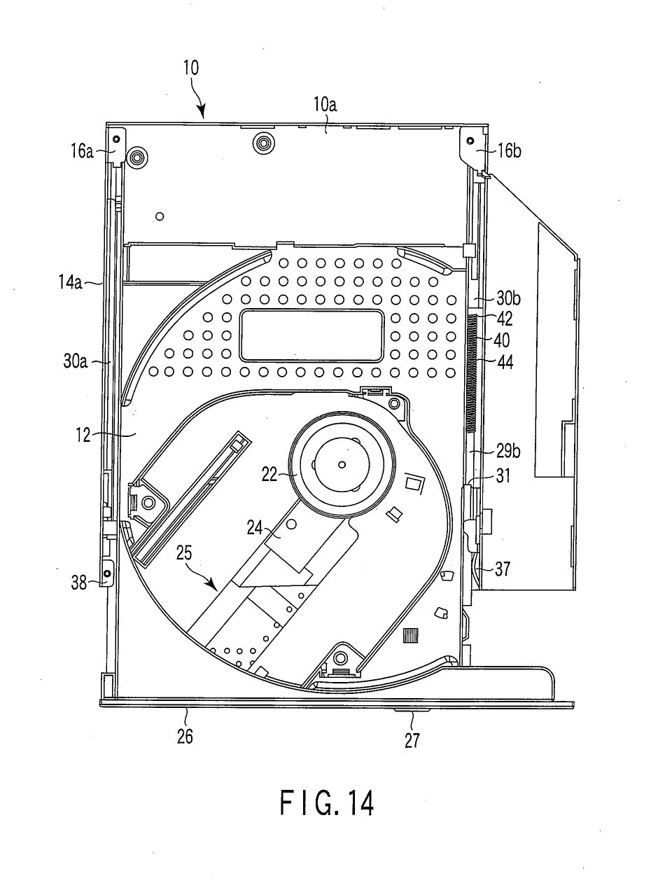

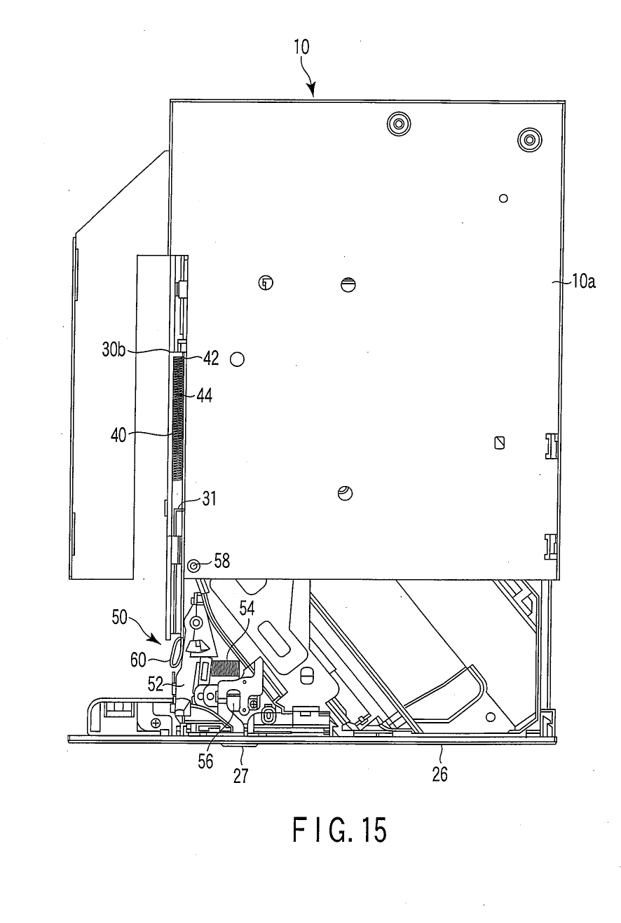

FIGS. 13A and 13B show locked and unlocked states, respectively, of the locking mechanism. FIGS. 14 and 15 show the top and bottom surfaces, respectively, of the optical disc drive with the disc tray 12 pushed out in the draw-out direction from the case 10 by the ejection mechanism.

As shown in FIGS. 12 and 13A, the locking mechanism 50 for locking the disc tray 12 in the loaded position includes a locking lever 52, a spring member 54, and a solenoid 56. The locking lever 52 is supported on the reverse side of the disc tray 12 so as to be rockable between locked and unlocked positions. The spring member 54 urges the locking lever toward the unlocked position. The solenoid 56 holds the locking lever in the locked position. When it is energized, the solenoid releases its hold on the locking lever, thereby allowing the lever to rock toward the unlocked position.

Further, the locking mechanism 50 includes a locking pin 58 (see FIG. 3) that is set up on the inner surface of the bottom cover 10a in the vicinity of the insertion port 10c. When the locking lever 52 is held in the locked position, the locking pin 58 is situated on a path of movement of the locking lever. Thus, the lever 52 abuts the pin 58, thereby preventing the disc tray 12 from moving in the draw-out direction and locking it in the loaded position.

The locking lever 52 is located near the rail 30b. The lever 52 extends toward the rail 30b and integrally includes an elastically deformable projection 60. The projection 60, which can engage with the press pawl 37 of the rail 30b, causes the locking lever 52 to rock from the unlocked position to the locked position as it is pressed by the press pawl.

In the locked state, as shown in FIGS. 12 and 13A, the locking lever 52 is held in the illustrated locked position by the solenoid 56. Thus, the lever 52 abuts the locking pin 58 on the case 10, and the disc tray 12 is prevented from moving in the draw-out direction and is locked in the loaded position.

If the eject button 27 is depressed to unload or load the optical disc 20, that is, to eject the disc tray 12, as shown in FIG. 13B, the solenoid 56 is energized to release its hold on the locking lever 52. Thereupon, the locking lever 52 is pressed by the spring member 54 so that it is rocked from the locked position to the illustrated unlocked position. In consequence, the lever 52 is disengaged from the locking pin 58, so that the disc tray 12 is unlocked.

When the disc tray 12 is unlocked, as shown in FIGS. 14 and 15, it is pressed toward the drawn-out position by the urging force of the compression coil spring 44 of the ejection mechanism and pushed out for a predetermined distance along the rails 30a and 30b from the case 10. Accordingly, an operator is allowed to hold an ejected part of the disc tray 12, and thereafter, the tray 12 is further drawn out to the drawn-out position by the operator. As this is done, the rails 30a and 30b slide along the guide portions 14a and 14b of the case 10 and are drawn out together with the disc tray 12 from the case 10. The operator can unload or load the optical disc 20 from or into the disc tray 12 by drawing out the tray 12 to the drawn-out position shown in FIG. 2.

In locating the disc tray 12 in the loaded position, the operator pushes it from the drawn-out position to the loaded position. Thereupon, the pair of rails 30a and 30b are also pushed along the guide portions 14 into the case 10. When the tray 12 is moved to the loaded position and if the rails 30a and 30b are pushed deep into the case 10, the projection 60 of the locking lever 52 is pushed by the press pawl 37 on the distal end portion of the rail 30b, and the lever 52 is rocked from the unlocked position to the locked position. Thereupon, the lever 52 is held in the locked position by the locking mechanism 50, so that the disc tray 12 is locked in the loaded position.

According to the optical disc drive constructed in this manner, the compression coil spring 44 that constitutes the ejection mechanism is held in the predetermined position by only being located in the rail holder groove 40, and can apply a desired urging force to the disc tray. Therefore, it is unnecessary to use any spring mounting member for mounting a spring for ejection, tray pressing member attached to the spring, etc. Accordingly, the number of essential components can be reduced, and the assembly work can be simplified. Thus, there may be obtained an optical disc drive that ensures improved reliability, reduced manufacturing costs, and better manufacturability.

The following is a description of an optical disc drive according to a second embodiment of the invention.

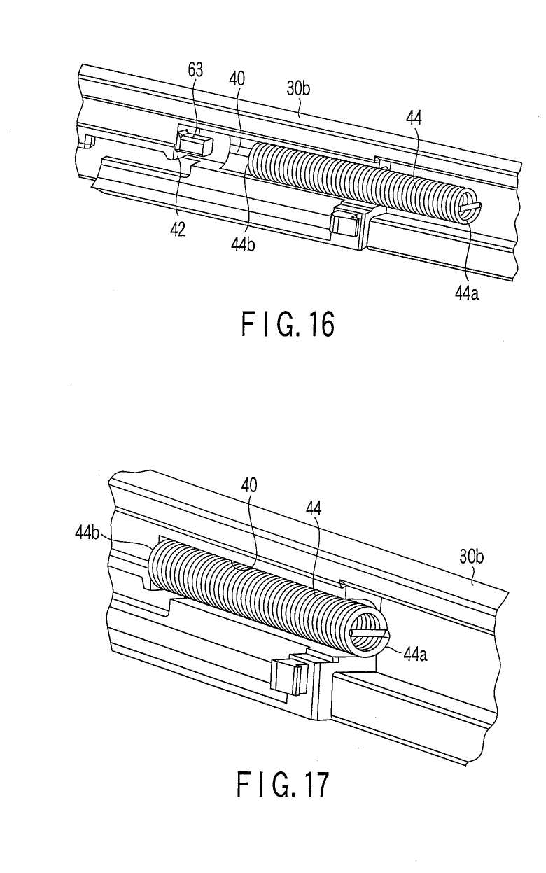

According to the second embodiment, as shown in FIGS. 16 and 17, a rail 30b includes a holder groove 40, in which a compression coil spring 44 of an ejection mechanism is located, and an abutting surface 42 on which one end of the coil spring abuts. A fixing boss 63 is molded integrally with the abutting surface 42 and projects into the holder groove 40. The boss 63 is inserted into one end 44b of the compression coil spring 44.

According to this arrangement, as in the first embodiment, the compression coil spring 44 can be easily fitted in the holder groove 40, and its position can be more securely regulated by the boss 63.

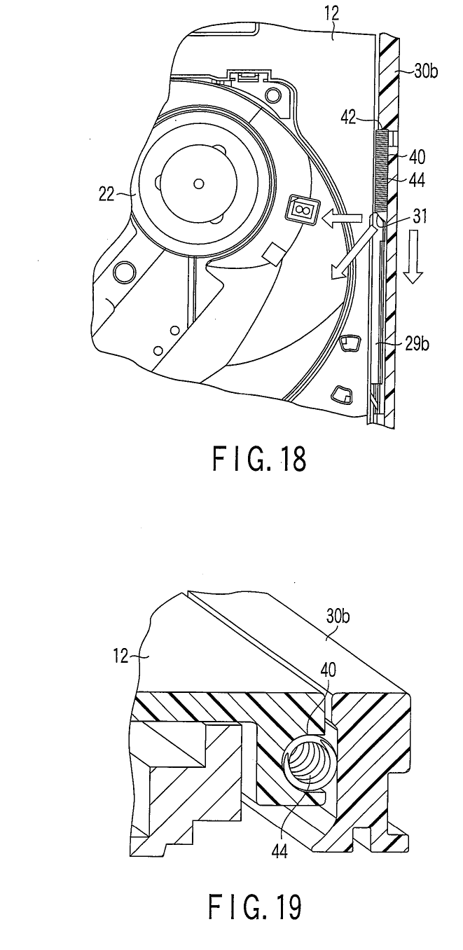

According to a third embodiment of the invention, as shown in FIG. 18, a guide rib 29b on a disc tray 12 includes an abutting surface 31 that abuts one end of a compression coil spring 44. The abutting surface extends obliquely to the direction in which the disc tray 12 is drawn out.

According to this arrangement, the urging force of the compression coil spring 44 is dispersed in the drawn-out direction and a direction perpendicular thereto, as indicated by arrows in FIG. 18. Thus, the compression coil spring 44 for ejection can prevent the disc tray 12 from jolting, thereby improving the resistance to vibration and shock.

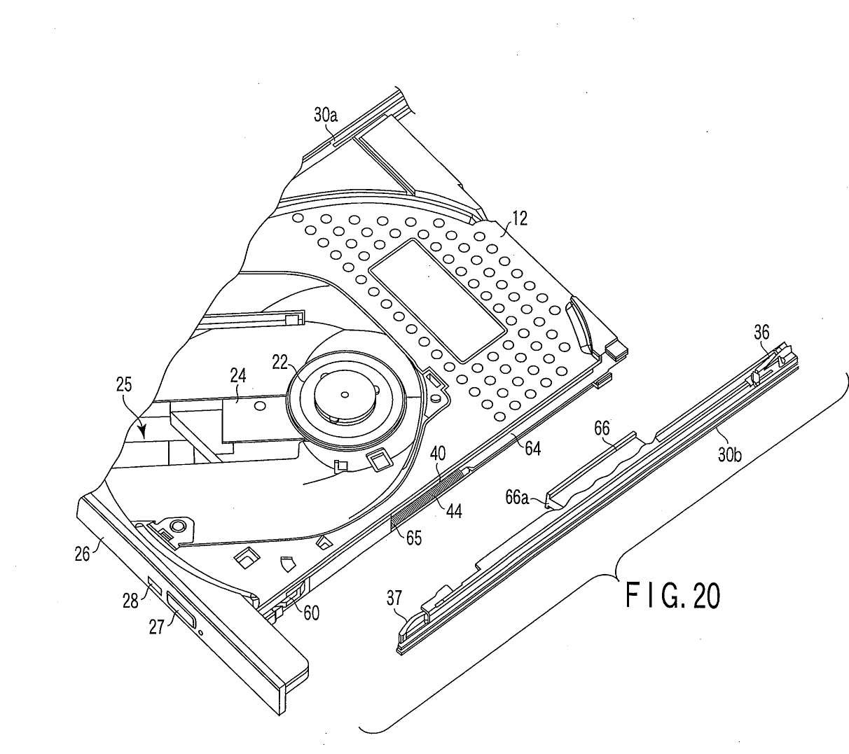

According to a fourth embodiment of the invention, as shown in FIGS. 19 and 20, a holder groove 40 is formed in a disc tray 12, and a compression coil spring 44 that constitutes an ejection mechanism is located in the holder groove. Specifically, a guide groove 64 and a holder groove 40 are formed in succession in one side edge of the disc tray 12. A rail 30b includes a guide rib 66 that projects toward the disc tray 12 and extends in the direction along which the disc tray is drawn out. The rail 30b is slidably mounted on the disc tray 12 with its guide rib 66 in engagement with the guide groove 64 of the disc tray.

A compression coil spring 44 is located in the holder groove 40 and held between the rail 30b and the disc tray 12. One end of the spring 44 abuts an abutting surface 65 of the disc tray, while the other end portion extends into the guide groove 64 and abuts an abutting surface 66a of the guide rib 66.

Thus, the same functions and effects as those of the first embodiment can be obtained even with use of the compression coil spring 44 located on the disc tray side.

In the second, third, and fourth embodiments, other configurations are the same as those of the first embodiment, so that like reference numbers are used to designate like portions, and a detailed description thereof is omitted. The same functions and effects of the first embodiment can also be obtained with the second, third, and fourth embodiments.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An optical disc drive comprising:
a case including a guide portion;
a disc tray which is located in the case so as to be able to be drawn out of the case and carries an optical disc thereon;
a guide mechanism which includes a rail slidably mounted on the disc tray and slidably supported on the guide portion of the case and supports the disc tray for movement between a predetermined loaded position in which the disc tray is situated in the case and a drawn-out position to which the disc tray is discharged from the case;
a locking mechanism which locks the disc tray in the loaded position; and
an ejection mechanism which includes a groove portion formed in the rail or the disc tray and a compression coil spring located in the groove portion and configured to urge the disc tray toward the drawn-out position and discharges the disc tray from the loaded position to the drawn-out position.

2. The optical disc drive according to claim 1, wherein the rail is slidably mounted on either side edge portion of the disc tray, the groove portion is formed on at least one of the rails, extends in a direction in which the disc tray is drawn out, and faces the disc tray, and the compression coil spring is located in the groove portion, having a central axis in alignment with the direction in which the disc tray is drawn out, and is held between the rail and the disc tray, the compression coil spring having one end abutting the rail and the other end abutting the disc tray.

3. The optical disc drive according to claim 2, wherein the disc tray includes a guide rib extending in the direction along which the disc tray is drawn out, and the rail includes a guide groove extending continuously with the groove portion and engaged with the guide rib, and the compression coil spring has one end abutting a wall surface of the rail which defines the groove portion and the other end abutting an end portion of the guide rib.

4. The optical disc drive according to claim 3, wherein the rail includes a boss protruding from the wall surface and in engagement with the compression coil spring.

5. The optical disc drive according to claim 3, wherein the end portion of the guide rib includes an abutting surface which abuts the other end of the compression coil spring and extends obliquely to the direction in which the disc tray is drawn out.

6. The optical disc drive according to claim 1, wherein the rail is molded from a synthetic resin or a metal.

7. The optical disc drive according to claim 1, wherein the groove portion is formed on the disc tray, extends in a direction in which the disc tray is drawn out, and faces the disc tray, and the compression coil spring is located in the groove portion, having a central axis in alignment with the direction in which the disc tray is drawn out, and is held between the rail and the disc tray, the compression coil spring having one end abutting the rail and the other end abutting the disc tray.
